(19) United States
(12) Patent Application Publication
(10) Pub. No.: US 2025/0269868 A1
(43) Pub. Date: Aug. 28, 2025

(54) Method for Operating a Driver Assistance System, Processing Device for Controlling a Driver Assistance System, and Motor Vehicle Having a Driver Assistance System

(71) Applicant: Bayerische Motoren Werke Aktiengesellschaft, Muenchen (DE)

(72) Inventors: Goekhan APAK, Landshut (DE); Martin SEDLMAYR, Wessobrunn (DE)

(21) Appl. No.: 18/858,577

(22) PCT Filed: Apr. 21, 2023
(86) PCT No.: PCT/EP2023/060385

§ 371 Date: Oct. 21, 2024

(30) Foreign Application Priority Data
May 9, 2022 (DE) 10 2022 111 522.4

(51) Int. Cl. B60W 50/16; B60W 10/08; B60W 50/14

(52) U.S. Cl. CPC B60W 50/16; B60W 10/08; B60W 2050/143; B60W 2050/146; B60W 2540/229; B60W 2710/08; B60W 2720/106

(57) ABSTRACT

A method for operating a driver assistance system includes capturing information indicating an imminent intervention of the driver assistance system in the guidance of the motor vehicle, providing an advance warning directed to a driver of the motor vehicle before the intervention, the advance warning comprising a first and a second warning signal, the first warning signal being optically and/or acoustically and/or haptically output, and the second warning signal comprising a kinesthetic jerk. The method also includes providing a main warning before the intervention, the main warning being subsequent to the advance warning, and the main warning comprising an acoustic warning signal and/or an optical warning signal.

### BACKGROUND AND SUMMARY

The present invention relates to a method for operating a driver assistance system, a processing device for controlling a driver assistance system, and a motor vehicle having a driver assistance system. In particular, the invention relates to providing a warning to a driver of such a motor vehicle before an intervention of the driver assistance system in the guidance of the motor vehicle.

A motor vehicle can comprise a driver assistance system, which can actively intervene in a longitudinal and/or lateral control of the motor vehicle. For example, an automatic braking assistant can permanently scan the surroundings of the motor vehicle for the presence of a hazardous situation. If such a situation is identified, a warning signal can thus be provided in order to give a driver of the motor vehicle the opportunity to resolve the hazardous situation, for example, in that he activates a brake himself or initiates a direction change. If the driver does not resolve the hazardous situation in a timely manner, the motor vehicle can be automatically decelerated.

It has been suggested that such a warning signal be provided by varying an acceleration of the motor vehicle in the longitudinal direction. For example, DE 10 2014 214 386 A1 proposes informing an occupant of a vehicle about a predetermined event by a kinesthetic signal.

However, certain procedures onboard the motor vehicle can be so important that a single signal is not sufficient to reliably inform a person.

One object underlying the present invention is therefore to specify improved technology for providing a warning to a driver of a motor vehicle. The invention achieves the object by the subjects of the present disclosure, which also reflects preferred embodiments.

According to a first aspect of the present invention, a method for operating a driver assistance system of a motor vehicle comprises the following steps: acquiring an item of information which indicates an upcoming intervention of a driver assistance system in the guidance of the motor vehicle, such as an emergency braking intervention; providing an advance warning directed to a driver of the motor vehicle before the intervention, wherein the advance warning comprises a first and a second warning signal, wherein the first warning signal is output optically and/or acoustically and/or haptically and the second warning signal comprises a kinesthetic jerk; and providing a main warning subsequent to the advance warning before the intervention, wherein the main warning comprises an acoustic and/or an optical warning signal.

The first and the second warning signals are preferably output at least partially simultaneously. The criticality of a transmitted warning can thus be increased by the use of at least two different warning channels. However, it is also possible that the second warning signal is output before the first warning signal (or vice versa).

The first warning signal preferably comprises an optical signal.

The main warning preferably takes place on at least two sensory perception channels, such as an optical and an acoustic channel. In other words, the main warning can comprise two or more warning signals like the advance warning, of which, for example, one is optical and one is acoustic.

It can be ensured by the use of two different sensory channels of the driver that the warning reaches him. At the same time, a requirement for a warning signal onboard the motor vehicle can be met, so that the method can also be used for delivering a safety-relevant warning signal. Such a requirement can consist of a law, a regulation, a guide, or a guideline, for example of a legislator or in the context of the NCAP (new car assessment program). The warning can thus relate, for example, to an existing hazardous situation, which can be mitigated after a predetermined time by activating a braking system.

The kinesthetic jerk preferably comprises a temporary change in the longitudinal acceleration of the motor vehicle. In particular if the driver controls the longitudinal movement of the motor vehicle, the jerk can primarily be perceptible to him as the second derivative of the speed. Another passenger may not consciously perceive the slight variation at all, consider it insignificant, or in any case may not be disturbed by it.

It is furthermore preferable for the kinesthetic jerk to be sufficiently minor and/or short such that a speed of the motor vehicle is not perceptibly changed for the driver. Although the jerk in the longitudinal direction is necessarily connected to an acceleration and thus to a change of the speed of the motor vehicle, for example, an elasticity or a play in the drivetrain can leave the speed of the motor vehicle relatively unchanged. Due to its shortness and/or low strength, the kinesthetic jerk can be reliably perceptible without noticeably influencing the longitudinal control of the motor vehicle.

For example, the jerk can be generated as a kinesthetic signal as described in the above-mentioned German patent application of the applicant DE 10 2014 214 386 A1.

The longitudinal acceleration of the motor vehicle is preferably varied by the jerk in a predetermined strength of, for example, 1 m/s² or less, in particular 0.8 m/s² or less. In principle, both a positive and a negative variation of the acceleration are conceivable here; however, it is preferably a braking jerk, i.e. a (preferably brief) negative variation of the acceleration. In other words, the kinesthetic jerk can be executed according to one preferred embodiment so that it causes a deceleration of the vehicle, wherein the deceleration is not more than 1 m/s², in particular not more than 0.8 m/s². In particular, the kinesthetic jerk can be executed so that the maximum achieved deceleration is in the range of 0.7 m/s² to 0.8 m/s².

Furthermore, the kinesthetic jerk can be executed so that it has a duration in the range of 300 ms to 1500 ms, in particular in the range of 300 ms to 450 ms, and particularly preferably in the range of 300 ms to 350 ms.

Furthermore, it can be provided that the kinesthetic jerk is executed so that a temporal change of the acceleration achieved in this case (i.e. at least at any point in time during the jerk) is in absolute value greater than or equal to 10 m/s³, preferably greater than or equal to 15 m/s³, and particularly preferably greater than or equal to 20 m/s³.

The above preferred durations and intensities of the jerk ensure, on the one hand that (with sufficiently large acceleration or deceleration gradients) the jerk is just long and fast enough, on the one hand, that it exceeds the human perceptibility threshold; on the other hand, a jerk having these parameters is still clearly delimited from an actual braking or acceleration jerk, which is accompanied by a clear influence of the vehicle kinematics. It is thus possible in this way that the jerk has (nearly only) an informative character. This is desirable since the vehicle guidance is to be influenced as little as possible directly by the jerk.

The preferred embodiments of the jerk proposed here with respect to duration and strength are based on the finding that an amplitude of a jerk which represents a perceptibility threshold for human perception can be reduced by a high gradient. In other words: If the acceleration gradient (in absolute value, i.e. neglecting its sign) is high, acceleration does not have to be nearly as high so that the person perceives the jerk. In contrast, if the jerk were built slowly with a comparatively small gradient, it would have to reach a higher amplitude to be perceived. Then, among other things, an area beyond a pure information jerk would be reached and the vehicle kinematics would be influenced undesirably strongly.

Furthermore, the finding is made use of in this context that a jerk having a short duration in the range of the human reaction time or below does not cause a fright reaction via a kinesthetic perception channel (in contrast, for example, to the acoustic perception, which has a shorter fright buildup time; this is clear, for example, in that even a very short bang can generate fear). It is thus possible due to the provision of a jerk having a duration in the above-mentioned ranges (for example 300 ms to 350 ms) to generate a signal which informas the driver but does not scare them.

Such a fast and short information jerk, which just reaches the perceptibility threshold but does not influence the vehicle kinematics unnecessarily strongly, can be generated particularly well by an electric drive of the motor vehicle. It is advantageous in relation to a conventional friction brake in this case that the electric machine has less or no need for readjustment and overall has fewer decelerations, so that even a very short jerk having a high initial acceleration gradient can be generated precisely and reproducibly. Thus, for example, by a suitable actuation of the electric machine, a 300-350 ms short jerk can be generated, the amplitude of which must not exceed 0.7-0.8 m/s² to be perceived as an information jerk. The key for the perceptibility here is the comparatively high initial gradient.

It is furthermore preferred that the longitudinal acceleration is changed in relation to a driver-controlled specification. If the driver is to just accelerate the motor vehicle, for example, with a predetermined strength, the kinesthetic jerk can be effectuated as a difference from the controlled acceleration. It can thus be ensured that the longitudinal movement of the motor vehicle can be completely controlled by the driver and nonetheless can be used to transmit the kinesthetic jerk.

The longitudinal acceleration can be changed with a predetermined course to effectuate the kinesthetic jerk. This course can extend, for example, like a rectangle, a triangle, a sawtooth, or a sine wave. The course can be determined so that the signal effect on the driver is sufficiently large and at the same time a temporary change of the speed of the vehicle is sufficiently small.

The time course of the longitudinal acceleration is preferably approximately needle-shaped or sawtooth-shaped, i.e. having comparatively high rising and/or falling gradients and without a pronounced plateau at a maximum (or minimum). In the case of a braking jerk, for example, a comparatively steep drop of the acceleration to a local minimum thus initially occurs and then immediately (i.e. without a pronounced pause in the range of the minimum) a steep rise again, for example, approximately to the starting value of the acceleration before the braking jerk.

It is particularly preferred that a degree of attentiveness of the driver is determined. This can take place for example already before the acquisition of the information about the upcoming intervention (for example, also continuously during the journey) and/or only thereafter.

According to one embodiment, it can then be provided that the advance warning having the second warning signal is only provided if it is established that the driver is inattentive (“inattentive driver detected”). Otherwise, for example, it can be provided that the advance warning only comprises the first (preferably optical) warning signal, but not the kinesthetic second warning signal. In other words, if an inattentive driver is detected, an advance warning on two perception channels (including a kinesthetic channel) can be provided, whereas otherwise an advance warning only takes place, for example, on an optical perception channel. Under certain circumstances, the two-channel advance warning can prevent a two-channel intensive main warning having to take place beforehand in any case in the case of a detected inattentive driver (for example, to meet specific NCAP requirements), which could be perceived as annoying by the driver, in particular with regard to possible false-positive events.

As already explained, the kinesthetic jerk is output to provide an advance warning. The advance warning has a longer prediction horizon than a main or acute warning and therefore also an increased error rate. In particular an incorrect warning can be perceived as less annoying due to the use of the kinesthetic jerk for the advance warning. The main or acute warning subsequent to the advance warning can have a higher prediction probability, but also a lower prediction horizon. The main warning can be provided to the drivers so that it is more urgent than the advance warning. For example, the main warning can be an intensive warning having a flashing optical display and an additional loud warning tone.

It is also within the scope of the invention that it is provided that a point in time for the output of the advance warning is determined in dependence on the determined degree of attentiveness of the driver.

If the warning relates, for example, to an upcoming intervention of a driving assistant, in particular an activation of a braking system, the advance warning can be given to an attentive driver between 1 second and 100 ms before the intervention. A less attentive driver (i.e. a detected inattentive driver) can already be warned earlier, for example, between 2seconds and 400 ms before the intervention.

In contrast to an acoustic warning, for example, the kinesthetic jerk can be very subtle, so that it can be perceived by the driver as informative, but not as annoying. A passenger other than the driver can also experience the kinesthetic jerk as less annoying than, for example, an acoustic warning.

In one embodiment of the method, it is determined that a predetermined reaction of the driver to the advance warning does not occur over a predetermined time or that a time to an event, about which a warning is made, has fallen below a predetermined time interval. In this case, further warning signals can be output to the driver. The further warning signals can correspond to the main waring and can use the same or other sensory channels of the driver. In particular an optical, an acoustic, a haptic, and a kinesthetic channel are available for the main warning. It can thus be provided in a method according to the invention that the main warning is only output if the predetermined reaction of the driver does not occur over the predetermined time and/or if a time to the event, about which a warning is made, has fallen below a predetermined time interval.

A further aspect of the present invention relates to a processing device for controlling a driver assistance system of a motor vehicle.

The processing device can be configured to entirely or partially execute a method described herein. For this purpose, the processing device can comprise a programmable microcomputer or microcontroller and the method can be provided at least partially in the form of a computer program product having program code. The computer program product can also be stored on a computer-readable data carrier. Features or advantages of the method can be transferred to the control device or vice versa.

The processing device can be configured in particular to execute the following steps: acquiring an item of information which indicates an upcoming intervention of a driver assistance system in the guidance of the motor vehicle; acquiring an item of information about an attentiveness state of a driver of the motor vehicle; generating control signals to provide an advance warning before the intervention, wherein the control signals are generated in such a way that the advance warning comprises an optical, acoustic, or haptic first warning signal and that the advance warning comprises a second warning signal in the form of a kinesthetic jerk in addition to the first warning signal, if the driver is inattentive according to the acquired information about his attentiveness state.

According to one refinement, the processing device can additionally be configured to determine whether a predetermined reaction of the driver to the advance warning takes place in a predetermined time; and to generate control signals to provide a main warning subsequent to the advance warning before the intervention if the predetermined reaction of the driver does not occur over the predetermined time. The main waring comprises an acoustic and/or an optical warning signal here. The main warning preferably addresses at least two perception channels, for example, an optical and an acoustic.

A further aspect of the invention is a motor vehicle having a driver assistance system, wherein the motor vehicle comprises the following elements: A processing device according to the above-mentioned aspect of the invention; an optical, acoustic, or haptic first output device to provide the first warning signal in dependence on the control signals; an electric drive machine: and a control device for the electric drive machine, wherein the control device is configured to change a longitudinal acceleration of the motor vehicle by the electric drive machine in dependence on the control signals in order to generate the kinesthetic second warning signal. The motor vehicle thus comprises an electric drive machine which is configured by a corresponding actuation by the control device to change the longitudinal acceleration of the motor vehicle and in this way to effectuate the kinesthetic jerk which forms the second warning signal of the advance warning.

The change of the longitudinal acceleration can take place in the positive or negative direction, so that the longitudinal acceleration is increased or reduced. A negative longitudinal acceleration can also be controlled by a braking system of the motor vehicle. In addition to the electric drive machine, still another drive machine can be provided on board the motor vehicle, in particular an internal combustion engine. By actuating the electric machine. the kinesthetic jerk can be controlled very sensitively and using fewer means. If the electric machine can be used for recuperation the provision of the kinesthetic jerk can be approximately energetically neutral if the negative longitudinal acceleration is caused to charge an intermediate storage device and the positive longitudinal acceleration is caused using energy from the intermediate storage device.

The invention will now be described in more detail with reference to the appended drawings.

### BRIEF DESCRIPTION OF THE DRAWINGS

FIG. 1 illustrates a system; and

FIG. 2 illustrates a flow chart of the method.

### DETAILED DESCRIPTION OF THE DRAWINGS

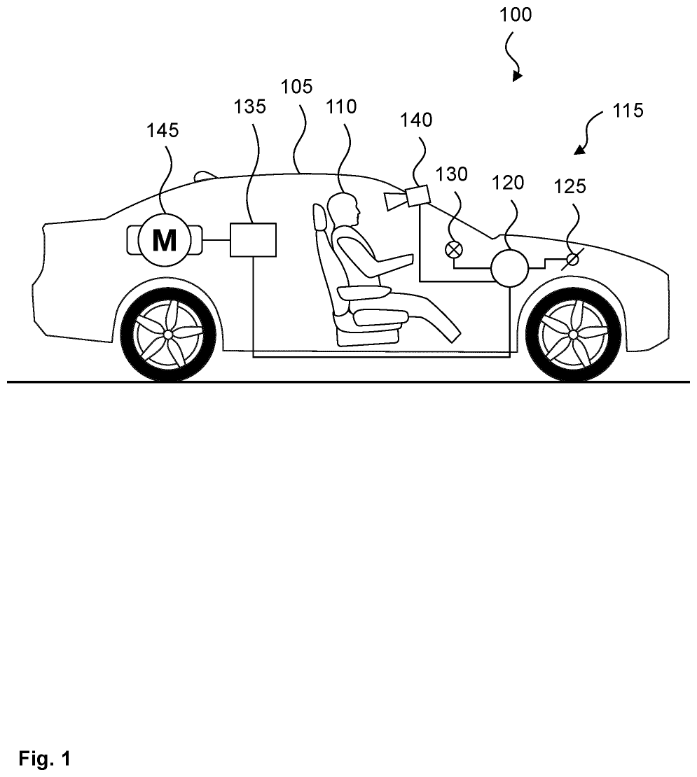

FIG. 1 shows a system 100 having a motor vehicle 105, which is controllable by a driver 110 on board and on board which a driver assistance system 115 is located.

The driver assistance system 115 is configured to provide warning signals to the driver 110. For this purpose, the motor vehicle 105 comprises a processing device 120, which is connected to an interface 125, a first output device 130, and a control device 135 for an electric drive machine 145 of the motor vehicle 105. In addition, an acquisition device 140 is provided in order to acquire the driver 110.

An item of information which indicates an upcoming intervention of a driver assistance system in the guidance of the motor vehicle 105 can be accepted via the interface 125. The information can originate from another system or subsystem onboard the motor vehicle 105 and in particular can indicate an upcoming event. The event can comprise, for example, an upcoming activation of a braking system, for example, to avoid a collision of the motor vehicle 105 with another object. A point in time in the future is preferably assigned to the event, at which the event is expected to occur.

The first output device 130 is configured to use an optical, acoustic, or haptic sensory channel of the driver 110. For this purpose, the first output device 130 can comprise an optical display, a loudspeaker, or haptic actuator. The haptic actuator can cause, for example, a steering wheel, a seat, or an armrest of the driver to vibrate.

The control device 135 is configured to actuate the electric drive machine 145 so that a kinesthetic jerk is conveyed to the driver 110 via the entire motor vehicle 105. The kinesthetic jerk preferably extends in the longitudinal direction of the vehicle 105 and can be effectuated, for example, by controlling a provided torque of the electric drive machine 145. The motor vehicle 105 can briefly be accelerated or decelerated in the longitudinal direction by the second control device 135 and electric drive machine 145 so that the driver 110 perceives the acceleration change.

The perception of the kinesthetic jerk can act on receptors of the musculoskeletal system of the driver 110. Such receptors can comprise in particular muscle spindles or Golgi tendon organs. The change of the longitudinal acceleration is preferably metered so that the perception of the kinesthetic jerk by the driver 110 runs at least partially consciously. In particular, a travel speed of the motor vehicle 105 may not change significantly or may not change perceptibly for the driver 110 due to the provided jerk.

A degree of attentiveness of the driver 110 can be determined by the acquisition device 140. The acquisition device 140 can comprise, for example, an interior camera, which acquires a facial expression, a blink, or a pupil widening of the driver 110. Other possible acquisition devices 140, for example, a steering angle sensor or a pedal sensor, can also be used.

The processing device 120 can vary the provision of a warning signal in the type, strength, and time interval before an event to which the warning is related. In particular, an advance warning can be provided earlier to the driver 110 the more inattentive he is. Two sensory channels independent of one another can be used for the advance warning, one of which can be addressed by the first output device 130 and the other by the kinesthetic jerk. Under certain circumstances, a main or acute warning can still be output at a later point in time, for which two sensory channels of the driver 110 independent of one another can also be used. The output devices 130, 135 and/or another output device on board the motor vehicle 105 can be used for this purpose. One or more channels used during the acute warning can differ from the channels used during the advance warning.

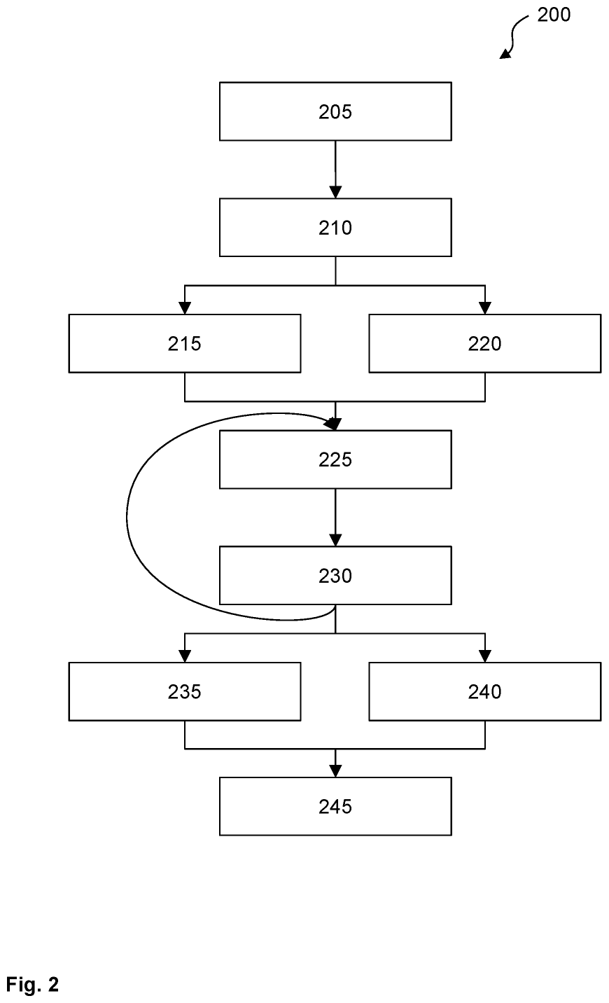

FIG. 2 shows a flow chart of a method 200 for providing a warning to a driver 110.

In a step 205, an item of information which indicates an upcoming intervention of the driver assistance system 115 in the guidance of the motor vehicle 105 can be acquired. The information can relate to an event and an associated point in time in the future. The event can be predicted for the point in time and in general it can be provided that the driver 110 is to be encouraged thereupon by one or more warnings to prevent the occurrence of the event.

In a step 210 which can occur before, after, or simultaneously with step 205 with respect to time, a degree of attentiveness of the driver 110 can be determined. For this purpose, the driver 110 can be acquired by the acquisition device 140.

Two warning signals can then be output simultaneously in order to convey an advance warning to the driver 110 before the intervention. In a step 215, a first warning signal can be output by the first output device 130, while in a step 220, a second warning signal can be provided by the control device 135 and the electric drive machine 145. The first warning signal is provided optically, acoustically, or haptically and the second warning signal comprises a kinesthetic jerk, which comprises the entire motor vehicle 105.

In a step 225, it can be checked whether a predetermined reaction of the driver 110 can be acquired. This reaction can be capable of not permitting the event, about which the warning is made, to occur. If the departure from a lane is warned of, for example, the reaction of the driver 110 can comprise a change of the course of the motor vehicle 105, so that the lane is kept. Different reactions to the warning are often possible. In the above example, the driver 110 could actively control a lane change, for example.

If the predetermined reaction should be acquired, the method 200 can end. Otherwise, it can be checked in a step 230 whether a predetermined time during which it was not possible to acquire the reaction in spite of provided warning signals has expired. If this is not the case, the sequence can return to step 225.

If the time has expired, further warning signals can be output to the driver 110. Analogously to steps 215 and 220, in steps 235 and 240, a further first warning signal and a further second warning signal can be output. The further warning signals can be output by any output devices, for example, again by the first output device 130. The warning signals provided in steps 235, 240 can correspond to a main warning and can be clearer, louder, brighter, more penetrating, or more aggressive than the warning signals of steps 215, 220, which can correspond to an advance warning.

Accordingly, it can be accepted at this point that a warning signal could be perceived as annoying by the driver 110 or also another person on board the motor vehicle 105. If one of the further warning signals comprises a kinesthetic jerk, this can be sufficiently long or sufficiently strong that it can be sensed by every person on board the motor vehicle 105. A travel speed of the motor vehicle 105 can be perceptibly changed for the person by the kinesthetic jerk of the main warning.

If the occurrence of the event, about which the warning is to be made, should be probable even after the main warning in steps 235, 240, in a step 245, the actual intervention can occur, such as an active control of the motor vehicle 105. In particular, the motor vehicle 105 can be controlled in the longitudinal direction and/or transverse direction. Furthermore preferably, the motor vehicle 105 can be controlled into a safe driving state, which can comprise stopping or coasting, for example. A driving intervention of the driver 110 can be overridden in this case.

1-13. (canceled)

14. A method for operating a driver assistance system of a motor vehicle, the method comprising:
acquiring an item of information that indicates an upcoming intervention of the driver assistance system in guidance of the motor vehicle;
providing an advance warning directed to a driver of the motor vehicle before the intervention, wherein the advance warning comprises a first and a second warning signal,
wherein the first warning signal is output optically and/or acoustically and/or haptically, and the second warning signal comprises a kinesthetic jerk; and
providing a main warning subsequent to the advance warning before the intervention wherein the main warning comprises an acoustic and/or an optical warning signal.

15. The method according to claim 14, wherein the kinesthetic jerk comprises a temporary change of a longitudinal acceleration of the motor vehicle.

16. The method according to claim 15, wherein the longitudinal acceleration is changed in relation to a driver-controlled specification.

17. The method according to claim 15, wherein the longitudinal acceleration is changed with a predetermined course.

18. The method according to claim 14, wherein the kinesthetic jerk is executed so that it has a duration in a range of 300 ms to 1500 ms.

19. The method according to claim 14, wherein the kinesthetic jerk is executed so that it causes a deceleration of the vehicle, and wherein the deceleration is not greater than 1 m/s2.

20. The method according to claim 19. wherein the kinesthetic jerk is executed so that a maximum achieved deceleration is in a range of 0.7 m/s2 to 0.8 m/s2.

21. The method according to claim 14, wherein the kinesthetic jerk is executed so that a change over time of the longitudinal acceleration which is achieved is in absolute value greater than or equal to 10 m/s3.

22. The method according to claim 14, comprising:
determining a degree of attentiveness of the driver,
wherein the advance warning having the second warning signal is only provided if it is determined that the driver is inattentive.

23. The method according to claim 14, comprising:
determining whether a predetermined reaction of the driver to the advance warning takes place in a predetermined time,
wherein the main warning is only provided if the predetermined reaction of the driver does not occur over the predetermined time.

24. A processing device for controlling a driver assistance system of a motor vehicle, wherein the processing device is configured to:
acquire an item of information that indicates an upcoming intervention of the driver assistance system in guidance of the motor vehicle;
acquire an item of information about an attentiveness state of a driver of the motor vehicle; and
generate control signals to provide an advance warning before the intervention, wherein the control signals are generated in such a way that:
the advance warning comprises an optical, acoustic, or haptic first warning signal, and
the advance warning comprises, in addition to the first warning signal, a second warning signal in a form of a kinesthetic jerk in response to the driver being determined to be inattentive according to the acquired information about his attentiveness state.

25. The processing device according to claim 24, wherein the processing device is further configured to:
determine whether a predetermined reaction of the driver to the advance warning takes place in a predetermined time; and
generate control signals to provide a main warning subsequent to the advance warning before the intervention if the predetermined reaction of the driver does not take place over the predetermined time, wherein the main warning comprises an acoustic and/or an optical warning signal.

26. A motor vehicle having a driver assistance system, wherein the motor vehicle comprises:
the processing device according to claim 24;
an optical, acoustic, or haptic first output device for providing the first warning signal in dependence on the control signals;
a electric drive machine; sod
a control device for the electric drive machine, wherein the control device is configured to change a longitudinal acceleration of the motor vehicle in dependence on the control signals by the electric drive machine in order to generate the kinesthetic second warning signal.
